(19) United States
(12) Patent Application Publication
(10) Pub. No.: US 2026/0005896 A1
(43) Pub. Date: Jan. 1, 2026

(54) IN-VEHICLE NETWORK SYSTEM AND ELECTRONIC CONTROL UNIT

(71) Applicant: TOYOTA JIDOSHA KABUSHIKI KAISHA, Toyota-shi (JP)

(72) Inventor: Taiki MIZUTANI, Miyoshi-shi (JP)

(73) Assignee: TOYOTA JIDOSHA KABUSHIKI KAISHA, Toyota-shi (JP)

(21) Appl. No.: 19/076,306

(22) Filed: Mar. 11, 2025

(30) Foreign Application Priority Data
Jun. 3, 2024 (JP) 2024-090126

(51) Int. Cl. H04L 12/40; H04L 67/12

(52) U.S. Cl. CPC H04L 12/4013; H04L 67/12; H04L 2012/40273

(57) ABSTRACT

A plurality of ECUs configuring a system includes a master ECU and a slave ECU. The master ECU distributes a second bandwidth within the bandwidth of a communication bus to the ECUs based on first request information and second request information. The ECUs adjust a transmission of a dynamic message such that a total sum of data lengths of the dynamic messages to be transmitted per unit of time to the communication bus does not exceed an allocation amount which is allocated to the ECUs within the second bandwidth.

### CROSS-REFERENCE TO RELATED APPLICATION

This application claims priority to Japanese Patent Application No. 2024-090126 filed on Jun. 3, 2024. The disclosure of the above-identified application, including the specification, drawings, and claims, is incorporated by reference herein in its entirety.

### BACKGROUND

### 1. Technical Field

The present disclosure relates to an in-vehicle network system including a plurality of electronic control units and an electronic control unit that constitutes the in-vehicle network system.

### 2. Description of Related Art

A system disclosed in Japanese Patent No. 6646725 (JP 6646725 B) includes a plurality of subscriber stations and a communication connection. Each of the subscriber stations can transmit and receive not only a static message but also a dynamic message via the communication connection. As a result, the system can also perform communication that is not anticipated in a design phase of the system.

### SUMMARY

When software of the subscriber station is updated, the number of dynamic messages to be transmitted per unit of time from the subscriber station to the communication connection may increase. In the system as described above, as the number of dynamic messages to be transmitted per unit of time from the subscriber stations to the communication connection increases, a communication load on the system increases. When the communication load on the system becomes excessive, communication quality of the system may deteriorate.

A first aspect of the present disclosure relates to an in-vehicle network system. The in-vehicle network system includes a plurality of electronic control units configured to transmit and receive a static message and a dynamic message via a communication bus.

In the in-vehicle network system, a total sum of data lengths of the static messages to be transmitted per unit of time to the communication bus is set not to exceed a first bandwidth within a bandwidth of the communication bus.

A bandwidth excluding the first bandwidth within the bandwidth of the communication bus is a second bandwidth.

The electronic control units are configured to transmit a plurality of the dynamic messages to the communication bus.

One of the electronic control units is a master electronic control unit, and an electronic control unit other than the master electronic control unit is a slave electronic control unit. The slave electronic control unit is configured to transmit, to the master electronic control unit, request information that is information including the number of dynamic messages of a first priority and the number of dynamic messages of a second priority that is a lower priority than the first priority, among the dynamic messages to be transmitted from the slave electronic control unit to the communication bus.

The master electronic control unit is configured to execute acquiring first request information and receiving second request information. The first request information is information including the number of dynamic messages of the first priority and the number of dynamic messages of the second priority, among the dynamic messages to be transmitted from the master electronic control unit to the communication bus. The second request information is the request information transmitted from the slave electronic control unit. The master electronic control unit is configured to execute allocating, based on the first request information and the second request information, the second bandwidth to the electronic control units such that an allocation amount to an electronic control unit with a greater number of dynamic messages of the first priority is larger than an allocation amount to an electronic control unit with a smaller number of dynamic messages of the first priority, among the electronic control units. The master electronic control unit is configured to execute transmitting bandwidth information to the slave electronic control unit. The bandwidth information is information regarding an allocation amount to the slave electronic control unit within the second bandwidth.

Each of the electronic control units is configured to adjust the number of dynamic messages to be transmitted per unit of time to the communication bus such that a total sum of data lengths of the dynamic messages to be transmitted per unit of time to the communication bus does not exceed an allocation amount allocated to the electronic control unit within the second bandwidth.

A second aspect of the present disclosure relates to an electronic control unit that is configured to transmit and receive a static message and a dynamic message via a communication bus. The electronic control unit constitutes an in-vehicle network system including a plurality of the electronic control units.

A total sum of data lengths of the static messages to be transmitted per unit of time to the communication bus is set not to exceed a first bandwidth within a bandwidth of the communication bus.

A bandwidth excluding the first bandwidth within the bandwidth of the communication bus is a second bandwidth.

The electronic control unit includes a processing circuit.

The processing circuit is configured to execute acquiring first request information and receiving second request information. The first request information is information including the number of dynamic messages of a first priority and the number of dynamic messages of a second priority that is a lower priority than the first priority, among the dynamic messages to be transmitted from the processing circuit to the communication bus. The second request information is information to be transmitted from another electronic control unit that constitutes the in-vehicle network system. The information includes the number of dynamic messages of the first priority and the number of dynamic messages of the second priority, among the dynamic messages to be transmitted from the other electronic control unit to the communication bus. The processing circuit is configured to execute allocating, based on the first request information and the second request information, the second bandwidth to the electronic control units such that an allocation amount to an electronic control unit with a greater number of dynamic messages of the first priority is larger than an allocation amount to an electronic control unit with a smaller number of dynamic messages of the first priority, among the electronic control units that constitute the in-vehicle network system. The processing circuit is configured to execute transmitting bandwidth information to the other electronic control unit. The bandwidth information is information regarding an allocation amount to the other electronic control unit within the second bandwidth. The processing circuit is configured to execute adjusting the number of dynamic messages to be transmitted per unit of time to the communication bus such that a total sum of data lengths of the dynamic messages to be transmitted per unit of time to the communication bus does not exceed an allocation amount to the processing circuit within the second bandwidth.

A third aspect of the present disclosure relates to an electronic control unit that is configured to transmit and receive a static message and a dynamic message via a communication bus. The electronic control unit constitutes an in-vehicle network system including a plurality of the electronic control units.

A total sum of data lengths of the static messages to be transmitted per unit of time to the communication bus is set not to exceed a first bandwidth within a bandwidth of the communication bus.

A bandwidth excluding the first bandwidth within the bandwidth of the communication bus is a second bandwidth.

The electronic control unit includes a processing circuit.

The processing circuit is configured to execute transmitting request information to another electronic control unit that constitutes the in-vehicle network system and receiving bandwidth information. The request information is information including the number of dynamic messages of a first priority and the number of dynamic messages of a second priority that is a lower priority than the first priority, among the dynamic messages to be transmitted from the processing circuit to the communication bus. The bandwidth information that is information regarding an allocation amount to the processing circuit within the second bandwidth. The information is transmitted from the other electronic control unit. The processing circuit is configured to execute adjusting the number of dynamic messages to be transmitted per unit of time to the communication bus such that a total sum of data lengths of the dynamic messages to be transmitted per unit of time to the communication bus does not exceed the allocation amount to the processing circuit within the second bandwidth.

The in-vehicle network system and the electronic control unit can suppress deterioration in communication quality even in a case where types of dynamic messages to be transmitted and received between a plurality of the electronic control units increase.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing an in-vehicle network system according to an embodiment;

FIG. 2 is a schematic diagram showing a data configuration of a static message;

FIG. 3 is a schematic diagram showing a data configuration of a dynamic message;

FIG. 4 is a schematic diagram showing an allocation of bandwidths of communication buses configuring the in-vehicle network system of FIG. 1;

FIG. 5 is a flowchart showing a series of processes executed by the master electronic control unit that configures the in-vehicle network system of FIG. 1;

FIG. 6 is a flowchart showing a series of processes executed by the slave electronic control unit that configures the in-vehicle network system of FIG. 1; and

FIG. 7 is a table showing an example of the operation of the in-vehicle network system of FIG. 1.

### DETAILED DESCRIPTION OF EMBODIMENTS

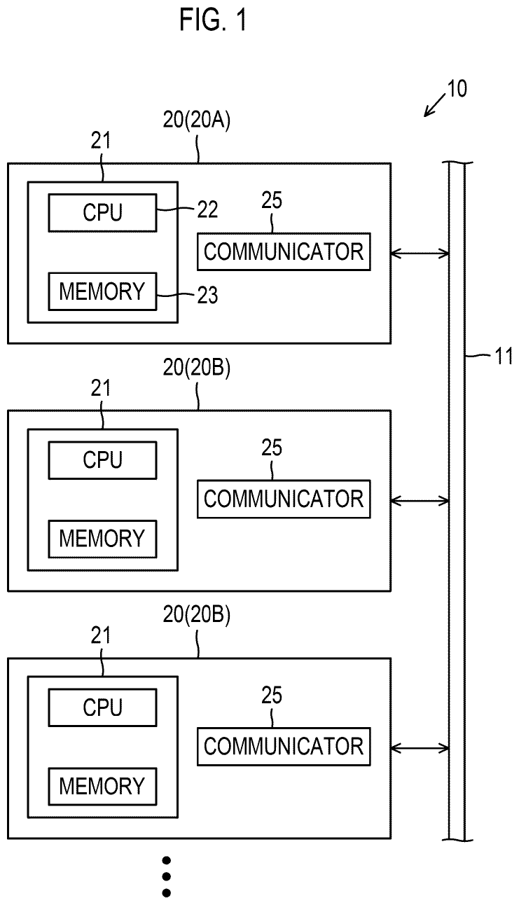

The embodiment of the in-vehicle network system and the electronic control unit will be described below with reference to FIGS. 1 to 7.

A configuration of the in-vehicle network system will be described. FIG. 1 shows an in-vehicle network system 10 mounted on a vehicle. The in-vehicle network system 10 includes a plurality of electronic control units (ECUs) 20. Each of the ECUs 20 is configured to transmit and receive messages via the communication bus 11. Hereinafter, the in-vehicle network system 10 is simply referred to as a “system 10”. An example of the communication bus 11 is a control area network (CAN) bus.

The ECUs 20 include an ECU that controls an in-vehicle actuator, such as a brake device, and an ADAS-ECU. The ECU 20 includes a processing circuit 21 and a communicator 25. The ECU 20 can transmit the message to the communication bus 11 via the communicator 25. The ECU 20 can receive the message from the communication bus 11 via the communicator 25.

A plurality of processing circuits 21 respectively have a CPU 22 and a memory 23. The memory 23 stores various control programs executed by the CPU 22. The processing circuits 21 can provide a service corresponding to the control program by the CPU 22 executing the control program of the memory 23.

In the present embodiment, among the ECUs 20, one ECU functions as a “master ECU 20A”, while the ECUs other than the master ECU 20A function as “slave ECUs 20B”. The master ECU 20A is an ECU having a function of integrally adjusting the transmission and reception of the message in the system 10. The slave ECU 20B adjusts the transmission of the message in accordance with a result of the adjustment of the master ECU 20A.

### Message

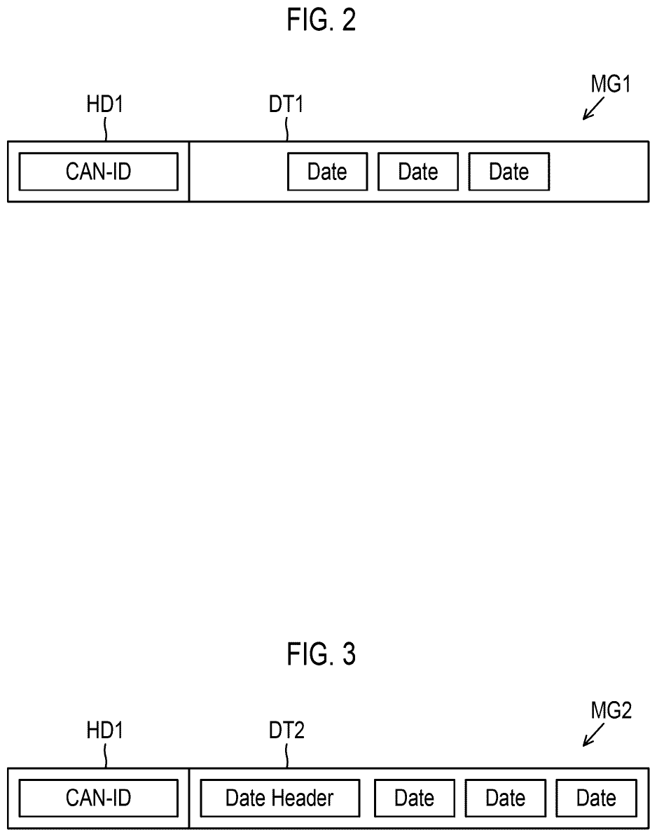

A message transmitted from the ECU 20 to the communication bus 11 will be described with reference to FIGS. 2 and 3.

The message includes a static message MG1 and a dynamic message MG2. The static message MG1 is a message that is assumed to be transmitted from the ECU 20 to the communication bus 11 in a design stage of the system 10. The dynamic message MG2 is a message that is not assumed to be transmitted from the ECU 20 to the communication bus 11 in the design stage of the system 10. For example, when the control program of the memory 23 is updated, a content of the service that can be provided by the system 10 may be changed. When the content of the service is changed, types of the messages transmitted from the ECU 20 to the communication bus 11 may be increased. In addition, for example, when a new control program is added to the memory 23, types of the services that can be provided by the system 10 may be increased. When the types of the services increase, the types of messages transmitted from the ECU 20 to the communication bus 11 may increase. The message that increases due to the change in the content of the service or the increase in the number of services is associated with the dynamic message.

FIG. 2 shows a data configuration of the static message MG1. A data length of the static message MG1 is fixed to a predetermined data length. The static message MG1 includes a header area HD1 and a data area DT1. The header area HD1 includes information indicating a CAN-ID. The CAN-ID is an ID for identifying the content of the message or an ECU which is a transmission destination. The data area DT1 includes at least one data to be transmitted to the other ECU 20 by transmitting the static message MG1.

FIG. 3 shows a data configuration of the dynamic message MG2. A data length of the dynamic message MG2, which is a length of data of the dynamic message MG2, is equal to the data length of the static message MG1. The dynamic message MG2 includes a header area HD2 and a data area DT2. The header area HD2 includes information indicating a CAN-ID.

The data area DT2 includes at least one data to be transmitted to the other ECU 20 by transmitting the dynamic message MG2. The data area DT2 includes a data ID. The data ID is, for example, an ID for identifying the type of the dynamic message or identifying the ECU which is a transmission destination.

In the present embodiment, the priority is set for the dynamic message MG2. The “priority” referred to herein is a priority for transmitting a message to the communication bus 11. A transmission frequency of the dynamic message MG2 having a high priority is higher than a transmission frequency of the dynamic message MG2 having a low priority. For example, among the priorities, a first priority is the highest, a second priority is lower than the first priority, and a third priority is lower than the first priority and the second priority.

### Communication Using Communication Bus

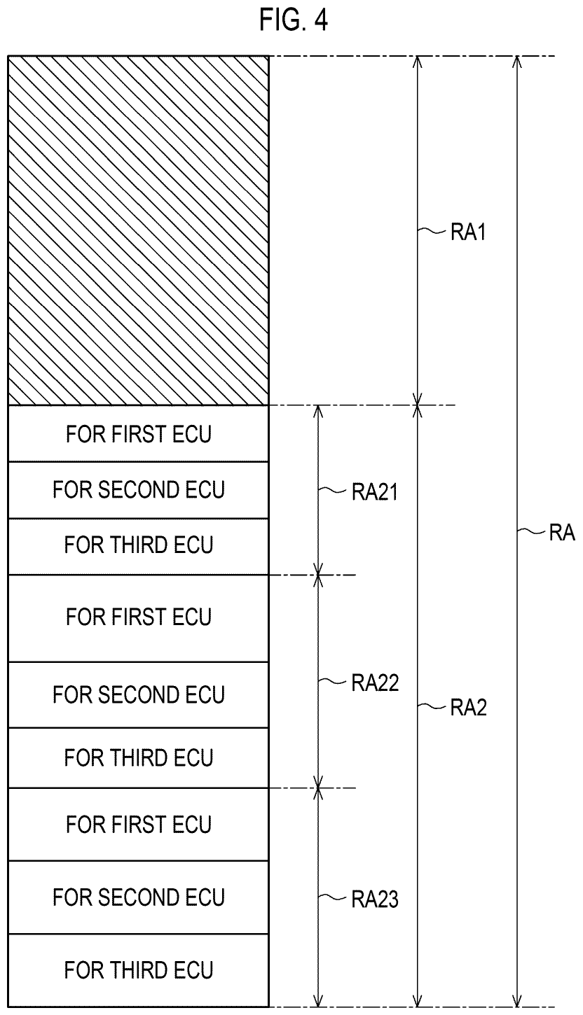

FIG. 4 shows a bandwidth RA of the communication bus 11. The bandwidth RA of the communication bus 11 is a maximum value of the data capacity that can be transmitted on the communication bus 11 per unit of time. The bandwidth RA includes a first bandwidth RA1 and a second bandwidth RA2. The sizes of the first bandwidth RA1 and the second bandwidth RA2 are determined in a setting stage of the system 10.

The first bandwidth RA1 is a bandwidth secured for transmitting the static message MG1. The first bandwidth RA1 is set such that a total sum of data lengths of the static messages MG1 transmitted to the communication bus 11 per unit of time does not exceed the first bandwidth RA1.

The second bandwidth RA2 is a bandwidth secured for transmitting the dynamic message MG2. A data capacity excluding the first bandwidth RA1 from the bandwidth RA of the communication bus 11 is the second bandwidth RA2. As described above, the data length of the dynamic message MG2 is decided in advance. In addition, the second bandwidth RA2 is also decided in advance.

As shown in FIG. 4, for example, the second bandwidth RA2 is allocated to the ECUs 20. The allocation of the second bandwidth RA2 to the ECUs 20 is changed in response to the update of the control program or the addition of the control program in at least one of the ECUs 20.

In the present embodiment, the second bandwidth RA2 can be divided into a plurality of bandwidths. For example, the second bandwidth RA2 can be divided into a bandwidth RA21, a bandwidth RA22, and a bandwidth RA23. In this case, the bandwidth RA21 is a bandwidth for the dynamic message MG2 of the first priority. The bandwidth RA22 is a bandwidth for the dynamic message MG2 of the second priority. The bandwidth RA23 is a bandwidth for the dynamic message MG2 of the third priority. A proportion of the bandwidth RA21 in the second bandwidth RA2 corresponds to a “first reference proportion”. A proportion of the bandwidth RA22 in the second bandwidth RA2 corresponds to a “second reference proportion”. In this case, the ratio of the bandwidth RA23 to the second bandwidth RA2 may be referred to as a “third reference proportion”.

Further, the bandwidth RA21 is allocated to the ECUs 20. In the example shown in FIG. 4, the bandwidth RA21 is allocated to a bandwidth for a first ECU, a bandwidth for a second ECU, and a bandwidth for a third ECU. Similarly, any of the bandwidths RA22, RA23 is also allocated to the ECUs 20.

As described above, the data length of the dynamic message MG2 is fixed. Therefore, for example, when the allocation amount to the first ECU within the second bandwidth RA2 is decided, the number of dynamic messages MG2 that can be transmitted to the communication bus 11 by the first ECU per unit of time is decided. Specifically, when the allocation amount to the first ECU is decided within the bandwidth RA21 for the dynamic message MG2 of the first priority, the number of the dynamic messages MG2 of the first priority that can be transmitted to the communication bus 11 by the first ECU per unit of time is decided. When the allocation amount to the first ECU within the bandwidth RA22 for the dynamic message MG2 of the second priority is decided, the number of the dynamic messages MG2 of the second priority that can be transmitted to the communication bus 11 by the first ECU per unit of time is decided. When the allocation amount to the first ECU within the bandwidth RA23 for the dynamic message MG2 of the third priority is decided, the number of the dynamic messages MG2 of the third priority that can be transmitted to the communication bus 11 by the first ECU per unit of time is decided.

### Series of Processes Executed by Master ECU

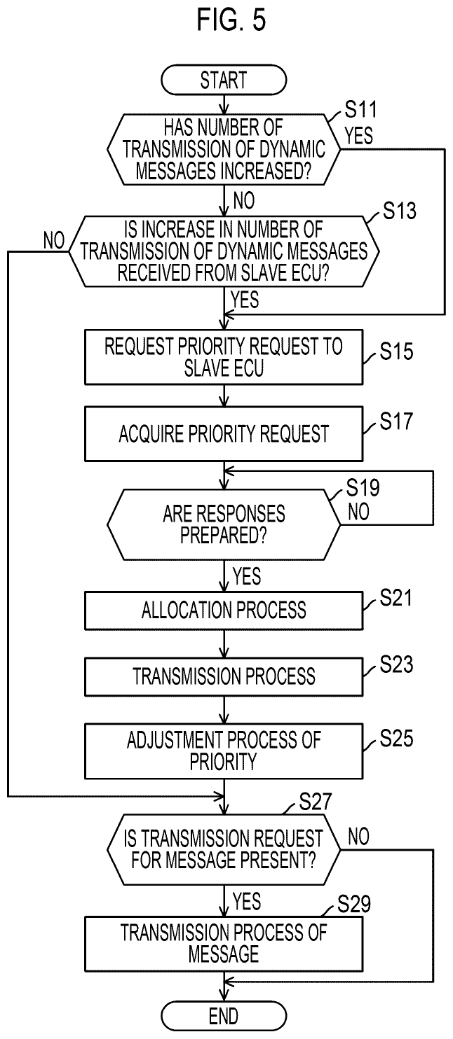

A series of processes executed by the CPU 22 will be described with reference to FIG. 5. The CPU 22 repeatedly executes the series of processes. The CPU 22 that executes the series of processes is a CPU provided in the master ECU 20A.

In S11, the CPU 22 determines whether or not the number of transmissions, which is the number of dynamic messages MG2 to be transmitted to the communication bus 11 by the CPU 22, is increased. As described above, in a case where the control program of the memory 23 is updated or a new control program is added to the memory 23, the number of times of transmission of the dynamic message MG2 may increase. In a case where the CPU 22 determines that the number of transmissions of the dynamic message MG2 is increased (S11: YES), the CPU 22 shifts the process to S15. In a case where the CPU 22 determines that the number of transmissions of the dynamic message MG2 is not increased (S11: NO), the CPU 22 shifts the process to S13.

In S13, the CPU 22 determines whether or not the slave ECU 20B receives the fact that the number of transmissions of the dynamic message MG2 to the communication bus 11 by the slave ECU 20B increases. In a case where the master ECU 20A receives that the number of transmissions is increased from the slave ECU 20B (S13: YES), the CPU 22 shifts the process to S15. In a case where the master ECU 20A does not receive that the number of transmissions is increased from the slave ECU 20B (S13: NO), the CPU 22 shifts the process to S27.

In S15, the CPU 22 requests a priority request to the slave ECUs 20B. The “priority request” includes the following information. The number of requests for the dynamic message MG2 of the first priority requested to be transmitted by the ECU 20.

The number of requests for the dynamic message MG2 of the second priority requested to be transmitted by the ECU 20.

The number of requests for the dynamic message MG2 of the third priority requested to be transmitted by the ECU 20.

In S17 that follows, the CPU 22 acquires the priority request of the master ECU 20A. The priority request of the master ECU 20A includes the following information. That is, the priority request of the master ECU 20A corresponds to a “first request information”.

The number of requests for the dynamic message MG2 of the first priority among the dynamic messages MG2 transmitted by the master ECU 20A to the communication bus 11.

The number of requests for the dynamic message MG2 of the second priority among the dynamic messages MG2 transmitted by the master ECU 20A to the communication bus 11.

The number of requests for the dynamic message MG2 of the third priority among the dynamic messages MG2 transmitted by the master ECU 20A to the communication bus 11.

In S19, the CPU 22 determines whether or not the priority request of the slave ECUs 20B is received as a response to the request in S15. The priority request of the slave ECU 20B includes the following information. That is, the priority request of the slave ECU 20B corresponds to a “second request information”.

The number of requests for the dynamic message MG2 of the first priority among the dynamic messages MG2 transmitted by the slave ECU 20B to the communication bus 11.

The number of requests for the dynamic message MG2 of the second priority among the dynamic messages MG2 transmitted by the slave ECU 20B to the communication bus 11.

The number of requests for the dynamic message MG2 of the third priority among the dynamic messages MG2 transmitted by the slave ECU 20B to the communication bus 11.

In a case where the master ECU 20A has not received the priority request from at least one of the slave ECUs 20B (S19: NO), the CPU 22 repeatedly executes the determination of S19. In a case where the master ECU 20A has received the priority request from the slave ECUs 20B (S19: YES), the CPU 22 shifts the process to S21.

In S21, the CPU 22 executes an allocation process of allocating the second bandwidth RA2 to the ECUs 20 based on the priority requests of the ECUs 20. In the allocation process, the CPU 22 allocates the second bandwidth RA2 to the ECUs 20 to satisfy the following condition.

An allocation amount of the dynamic message MG2 of the first priority to the ECU 20 having a large number of requests for the dynamic message MG2 of the first priority within the bandwidth RA21 is larger than an allocation amount of the dynamic message MG2 of the first priority to the ECU 20 having a small number of requests for the dynamic message MG2 of the first priority within the bandwidth RA21.

An allocation amount of the dynamic message MG2 of the second priority to the ECU 20 having a large number of requests for the dynamic message MG2 of the second priority within the bandwidth RA22 is larger than an allocation amount of the dynamic message MG2 of the second priority to the ECU 20 having a small number of requests for the dynamic message MG2 of the second priority within the bandwidth RA22.

An allocation amount of the dynamic message MG2 of the third priority to the ECU 20 having a large number of requests for the dynamic message MG2 of the third priority within the bandwidth RA23 is larger than an allocation amount of the dynamic message MG2 of the third priority to the ECU 20 having a small number of requests for the dynamic message MG2 of the third priority within the bandwidth RA23.

Here, an example of the allocation process will be described.

The CPU 22 derives a first request transmission number K1, a second request transmission number K2, and a third request transmission number K3 based on the priority requests of the ECUs 20. The first request transmission number K1 is a total of the numbers of requests for the dynamic message MG2 of the first priority transmitted by the ECUs 20. The second request transmission number K2 is a total of the number of requests for the dynamic message MG2 of the second priority transmitted by the ECUs 20. The third request transmission number K3 is a total of the numbers of requests for the dynamic message MG2 of the third priority transmitted by the ECUs 20.

The CPU 22 derives the bandwidth RA21, the bandwidth RA22, and the bandwidth RA23 from the second bandwidth RA2 based on the first request transmission number K1, the second request transmission number K2, and the third request transmission number K3. For example, among a plurality of request transmission numbers K1 to K3, it is assumed that the second request transmission number K2 is the largest. In this case, the CPU 22 derives a plurality of bandwidths RA21, RA22, RA23 such that the bandwidth RA22 is larger than the other bandwidths RA21, RA22. For example, among a plurality of request transmission numbers K1 to K3, it is assumed that a first request transmission number K1 is the smallest. In this case, the CPU 22 derives a plurality of bandwidths RA21, RA22, RA23 such that the bandwidth RA21 is smaller than the other bandwidths RA22, RA23.

The CPU 22 derives a first number C1 that is the number of dynamic messages MG2 of the first priority that can be transmitted from the ECUs 20 to the communication bus 11 per unit of time, based on the bandwidth RA21. In this case, the CPU 22 derives the first number C1 such that the first number C1 increases as the bandwidth RA21 increases. Similarly, the CPU 22 derives a second number C2 that is the number of dynamic messages MG2 of the second priority that can be transmitted from the ECUs 20 to the communication bus 11 per unit of time, based on the bandwidth RA22. The CPU 22 derives a third number C3, which is the number of dynamic messages MG2 of the third priority that can be transmitted from the ECUs 20 to the communication bus 11 per unit of time, based on the bandwidth RA23.

Therefore, when the total sum of the data lengths of the dynamic messages of the first priority transmitted from the ECUs 20 to the communication bus 11 is set as the first data capacity, the CPU 22 can derive the first number C1 such that a proportion of the first data capacity to the second bandwidth RA2 falls within the first reference proportion. When the total sum of the data lengths of the dynamic messages of the second priority transmitted from the plurality of ECUs 20 to the communication bus 11 is set as the second data capacity, the CPU 22 can derive the second number C2 such that a proportion of the second data capacity to the second bandwidth RA2 falls within the second reference proportion. When the total sum of the data lengths of the dynamic messages of the third priority transmitted from the plurality of ECUs 20 to the communication bus 11 is set as the third data capacity, the CPU 22 can derive the third number C3 such that a proportion of the third data capacity to the second bandwidth RA2 falls within the third reference proportion.

The CPU 22 allocates the first number C1 to the ECUs 20. In this case, the CPU 22 allocates the first number C1 to the ECUs 20 in response to the number of requests for the dynamic message MG2 of the first priority transmitted by the ECU 20. For example, the CPU 22 allocates the first number C1 to the ECUs 20 such that an allocation to the ECU 20 having a large number of requests is larger than an allocation to the ECU 20 having a small number of requests.

As in a case of the first number C1, the CPU 22 allocates the second number C2 to the ECUs 20. The CPU 22 allocates the third number C3 to the ECUs 20. Thereafter, the CPU 22 shifts the process to S23.

In S23, the CPU 22 executes a transmission process of transmitting the execution result of the allocation process to the slave ECU 20B. In the transmission process, the CPU 22 transmits the bandwidth information that is information regarding the allocation amount to the slave ECU 20B within the second bandwidth RA2 to the slave ECU 20B.

In S25 that follows, the CPU 22 executes an adjustment process of the priority of the dynamic message MG2 transmitted by the master ECU 20A. Specifically, the CPU 22 adjusts the number of dynamic messages MG2 of the first priority such that the number of requests for the dynamic message MG2 of the first priority transmitted by the master ECU 20A is equal to or less than a decided number that is an allocation number to the master ECU 20A within the first number C1. For example, in a case where the number of requests for the dynamic message MG2 of the first priority transmitted by the master ECU 20A is larger than the decided number that is the allocation number to the master ECU 20A among the first number C1, the CPU 22 reduces the number of the dynamic message MG2 of the first priority. In this case, the CPU 22 may change a part of the dynamic message MG2 of the first priority transmitted by the master ECU 20A to the dynamic message MG2 of the second priority.

Similarly, the CPU 22 adjusts the number of dynamic messages MG2 of the second priority such that the number of requests for the dynamic messages MG2 of the second priority transmitted from the master ECU 20A is equal to or less than a decided number that is an allocation number to the master ECU 20A among the second number C2. The CPU 22 adjusts the number of the dynamic messages MG2 of the third priority such that the number of requests of the dynamic messages MG2 of the third priority transmitted by the master ECU 20A is equal to or less than a decided number that is an allocation number to the master ECU 20A among the third number C3.

In the adjustment process, the CPU 22 assigns the CAN-ID to each of the dynamic messages MG2 in accordance with the priority. When the adjustment process of S25 ends, the CPU 22 shifts the process to S27.

In S27, the CPU 22 determines whether or not there is a transmission request for the message. In a case where there is a transmission request for the message (S27: YES), the CPU 22 shifts the process to S29. In a case where there is no transmission request for the message (S27: NO), the CPU 22 temporarily ends the series of processes.

In S29, the CPU 22 executes a transmission process of the message. In the transmission process, when the dynamic message MG2 is transmitted, the CPU 22 transmits the dynamic message MG2 to the communication bus 11 in accordance with the adjustment process of S25. That is, the CPU 22 can adjust the number of dynamic messages MG2 per unit of time such that the total sum of the data lengths of the dynamic messages MG2 to be transmitted to the communication bus 11 per unit of time does not exceed the allocation amount within the second bandwidth RA2 to the CPU 22. Thereafter, the CPU 22 temporarily ends the series of processes.

### Series of Processes Executed by Slave ECU

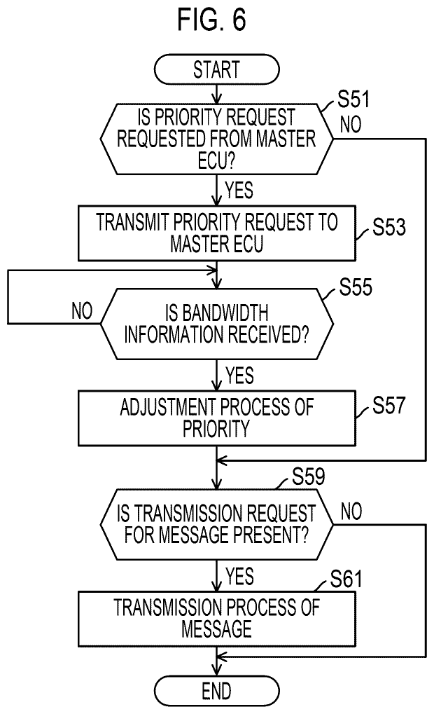

A series of processes executed by the CPU 22 will be described with reference to FIG. 6. The CPU 22 repeatedly executes the series of processes. The CPU 22 that executes the series of processes is a CPU provided in the slave ECU 20B.

In S51, the CPU 22 determines whether or not the priority request is requested from the master ECU 20A. In a case where the priority request is requested (S51: YES), the CPU 22 shifts the process to S53. In a case where the priority request is not requested (S51: NO), the CPU 22 shifts the process to S59.

In S53, the CPU 22 transmits the priority request of the CPU 22 to the master ECU 20A. The priority request of the CPU 22 is a response to the request in S51.

In S55 that follows, the CPU 22 determines whether or not the slave ECU 20B has received the bandwidth information transmitted by the master ECU 20A through the execution of the processing of S23. In a case where the slave ECU 20B has not received the bandwidth information (S55: NO), the CPU 22 repeats the determination of S55 until the slave ECU 20B can receive the bandwidth information. In a case where the slave ECU 20B has received the bandwidth information (S55: YES), the CPU 22 shifts the process to S57.

In S57, the CPU 22 executes the adjustment process of the priority of the dynamic message MG2 transmitted by the slave ECU 20B. The content of the adjustment process executed here is the same as the adjustment process executed by the master ECU 20A in S25. When the adjustment process ends, the CPU 22 shifts the process to S59.

In S59, the CPU 22 determines whether or not there is a transmission request of the message. In a case where there is a transmission request of the message (S59: YES), the CPU 22 shifts the process to S61. In a case where there is no transmission request of the message (S59: NO), the CPU 22 temporarily ends the series of processes.

In S59, the CPU 22 executes the transmission processing of the message. In the transmission process, when the dynamic message MG2 is transmitted, the CPU 22 transmits the dynamic message MG2 to the communication bus 11 in accordance with the adjustment process of S57. That is, the CPU 22 can adjust the number of dynamic messages MG2 per unit of time such that the total sum of the data lengths of the dynamic messages MG2 to be transmitted to the communication bus 11 per unit of time does not exceed the allocation amount within the second bandwidth RA2 to the CPU 22. When the CPU 22 ends the transmission process, the CPU 22 temporarily ends the series of processes.

### Action and Effect of Embodiment

In the system 10, the static message MG1 and the dynamic message MG2 are transmitted and received between the ECUs 20. Among the bandwidth RA of the communication bus 11, a first bandwidth RA1 is a bandwidth for the static message MG1. As a result, even when the number of dynamic messages MG2 transmitted from the ECU 20 to the communication bus 11 increases, the bandwidth for the static message MG1 is secured.

Among the ECUs 20, the slave ECU 20B transmits the priority request to the master ECU 20A. The priority request includes the number of dynamic messages MG2 of the first priority to be transmitted to the communication bus 11 by the priority request, the number of dynamic messages MG2 of the second priority, and the number of dynamic messages MG2 of the third priority. Therefore, the priority request transmitted by the slave ECU 20B corresponds to the “second request information”.

The master ECU 20A acquires a priority request of the master ECU 20A. The priority request corresponds to the “first request information”. The master ECU 20A receives the priority request transmitted from the slave ECU 20B. Then, the master ECU 20A allocates the second bandwidth RA2 to the ECUs 20 based on the priority requests of the ECUs 20.

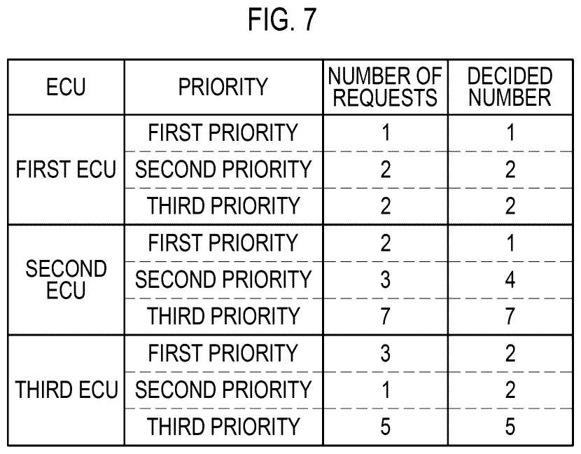

Here, with reference to FIG. 7, an example of a method of allocating the second bandwidth RA2 to the ECUs 20 will be described. The number of dynamic messages MG2 for which the ECU 20 requests transmission is referred to as a “number of requests”. The number of dynamic messages MG2 that can be transmitted by the ECU 20, which is determined by the allocation of the second bandwidth RA2, is referred to as a “decided number”.

The number of requests of the dynamic message MG2 of the first priority of the first ECU is 1, the number of requests for the dynamic message MG2 of the second priority of the first ECU is 2, and the number of requests of the dynamic message MG2 of the third priority of the first ECU is 2. The number of requests of the second ECU and the third ECU is as shown in FIG. 7. In this case, the first request transmission number K1 is 6, the second request transmission number K2 is 6, and the third request transmission number K3 is 14. In the master ECU 20A, the second bandwidth RA2 is divided into the bandwidths RA21, RA22, RA23 based on the request transmission numbers K1 to K3. Then, the first number C1 is derived based on the bandwidth RA21. The second number C2 is derived based on the bandwidth RA22. The third number C3 is derived based on the bandwidth RA23.

The first number C1 is allocated to the ECUs 20 based on the number of requests of the dynamic message MG2 of the first priority of the ECUs 20. The second number C2 is allocated to the ECUs 20 based on the number of requests of the dynamic message MG2 of the second priority of the ECUs 20. The third number C3 is allocated to the ECUs 20 based on the number of requests of the dynamic message MG2 of the third priority of the ECUs 20. In the master ECU 20A, the results of such processing are transmitted to the slave ECUs 20B.

In each of the ECUs 20, a process of adjusting the priority of the dynamic message MG2 is executed. For example, in the second ECU among the ECUs 20, the decided number of the dynamic messages MG2 of the first priority is 1. The decided number of the dynamic message MG2 of the second priority is 4, and the decided number of the dynamic message MG2 of the third priority is 7. In the example shown in FIG. 7, in the second ECU, the number of requests of the dynamic message MG2 of the first priority is 2, while the decided number of the dynamic message MG2 of the first priority is 1. Therefore, in the second ECU, one of the two dynamic messages MG2 of the first priority is changed to the dynamic message MG2 of the second priority. Such process is also executed by the first ECU and the third ECU.

Thereafter, in the case where the dynamic message MG2 is transmitted by the ECUs 20, the number of transmissions of the dynamic message MG2 having the first priority per unit of time does not exceed the decided number. The number of transmissions of the dynamic message MG2 of the second priority per unit of time does not exceed the decided number. The number of transmissions of the dynamic message MG2 of the third priority per unit of time does not exceed the decided number.

As a result, the transmission of the number of messages transmitted from the ECUs 20 to the communication bus 11, which exceeds the bandwidth RA of the communication bus 11, is suppressed. As a result, a communication load of the system 10 is suppressed from being excessively increased. In addition, in the system 10, a first bandwidth RA1 for transmitting the static message MG1 is secured. Therefore, even when the kind of the dynamic message MG2 to be transmitted is increased, the static message MG1 can be transmitted and received between the ECUs 20. Therefore, the system 10 can suppress the decrease in the communication quality even when the kind of the dynamic message MG2 to be transmitted and received between the ECUs 20 increases.

### Modification Example

The embodiments can be modified as follows. The embodiments and the following modification examples can be combined with each other within a range that does not cause a technical contradiction.

In the embodiment, the number of priorities may be a number other than three as long as the number is two or more.

The number of ECUs configuring the system 10 may be a number other than three as long as the number is two or more.

In a case where the first bandwidth RA1 is larger than the total of the data lengths of the static messages MG1 transmitted from the ECUs 20 to the communication bus 11, the CPU 22 may execute the following process in the adjustment process of S25 or S57. For example, in a case where the number of requests for the dynamic message MG2 of the first priority is larger than the decided number of the dynamic message MG2 of the first priority, the CPU 22 may assign the CAN-ID for the static message MG1 to a part of the dynamic message MG2 of the first priority. In this case, the CPU 22 can transmit the dynamic message MG2 to the communication bus 11 without reducing the transmission frequency of the dynamic message MG2 to which the CAN-ID for the static message MG1 is assigned.

The sizes of the bandwidths RA21, RA22, RA23 may be fixed.

The ECU 20 is not limited to executing software process and includes a CPU and a ROM. That is, the ECU 20 may have any of the following configurations (a), (b), and (c).
(a) The ECU 20 includes one or more processors that execute various processes in accordance with a computer program. The processor includes a CPU and a memory, such as a RAM and a ROM. The memory stores a program code or an instruction configured to cause the CPU to execute the process. The memory, that is, the computer-readable medium includes any usable medium that can be accessed by a general-purpose or dedicated computer.
(b) The ECU 20 includes one or more dedicated hardware circuits that execute various processes. Examples of the dedicated hardware circuits include an application specific integrated circuit (ASIC) or a field programmable gate array (FPGA).
(c) The ECU 20 includes one or more processors that execute a part of the various processes in accordance with a computer program, and one or more dedicated hardware circuits that execute the remaining processes of the various processes.

The expression “at least one” used in the present specification means “one or more” of desired options. As an example, the expression “at least one” used in the present specification means “solely one choice” or “both two choices” in a case where the number of choices is two. As another example, the expression “at least one” used in the present specification means “solely one choice” or “a combination of two or more arbitrary choices” when the number of choices is three or more.

What is claimed is:

1. An in-vehicle network system comprising a plurality of electronic control units configured to transmit and receive a static message and a dynamic message via a communication bus, wherein:
a total sum of data lengths of the static messages to be transmitted per unit of time to the communication bus is set not to exceed a first bandwidth within a bandwidth of the communication bus;
a bandwidth excluding the first bandwidth within the bandwidth of the communication bus is a second bandwidth;
the electronic control units are configured to transmit a plurality of the dynamic messages to the communication bus;
one of the electronic control units is a master electronic control unit, and an electronic control unit other than the master electronic control unit is a slave electronic control unit;
the slave electronic control unit is configured to transmit, to the master electronic control unit, request information that is information including the number of dynamic messages of a first priority and the number of dynamic messages of a second priority that is a lower priority than the first priority, among the dynamic messages to be transmitted from the slave electronic control unit to the communication bus;
the master electronic control unit is configured to execute:
acquiring first request information that is information including the number of dynamic messages of the first priority and the number of dynamic messages of the second priority, among the dynamic messages to be transmitted from the master electronic control unit to the communication bus;
receiving second request information that is the request information transmitted from the slave electronic control unit;
allocating, based on the first request information and the second request information, the second bandwidth to the electronic control units such that an allocation amount to an electronic control unit with a greater number of dynamic messages of the first priority is larger than an allocation amount to an electronic control unit with a smaller number of dynamic messages of the first priority, among the electronic control units; and
transmitting, to the slave electronic control unit, bandwidth information that is information regarding an allocation amount to the slave electronic control unit within the second bandwidth; and
each of the electronic control units is configured to adjust the number of dynamic messages to be transmitted per unit of time to the communication bus such that a total sum of data lengths of the dynamic messages to be transmitted per unit of time to the communication bus does not exceed an allocation amount allocated to the electronic control unit within the second bandwidth.

2. The in-vehicle network system according to claim 1, wherein:
a total sum of data lengths of the dynamic messages of the first priority to be transmitted from the electronic control units to the communication bus is a first data capacity, and a total sum of data lengths of the dynamic messages of the second priority to be transmitted from the electronic control units to the communication bus is a second data capacity;
the master electronic control unit is configured to:
derive a first number that is the number of dynamic messages of the first priority to be transmitted per unit of time from the electronic control units to the communication bus such that a proportion of the first data capacity within the second bandwidth falls within a first reference proportion;
derive a second number that is the number of dynamic messages of the second priority to be transmitted per unit of time from the electronic control units to the communication bus such that a proportion of the second data capacity within the second bandwidth falls within a second reference proportion;
allocate, based on the first request information and the second request information, the first number to the electronic control units such that a number to be allocated to the electronic control unit with a greater number of dynamic messages of the first priority is greater than a number to be allocated to the electronic control unit with a smaller number of dynamic messages of the first priority;
allocate, based on the first request information and the second request information, the second number to the electronic control units such that a number to be allocated to an electronic control unit with a greater number of dynamic messages of the second priority is greater than a number to be allocated to an electronic control unit with a smaller number of dynamic messages of the second priority; and
transmit, to the slave electronic control unit, as the bandwidth information, information regarding a number allocated to the slave electronic control unit from the first number and a number allocated to the slave electronic control unit from the second number; and
each of the electronic control units is configured to adjust the transmission of the dynamic message to the communication bus to satisfy each of conditions:
the number of dynamic messages of the first priority to be transmitted per unit of time to the communication bus does not exceed an allocation number to the electronic control unit from the first number; and
the number of dynamic messages of the second priority to be transmitted per unit of time to the communication bus does not exceed an allocation number to the electronic control unit from the second number.

3. The in-vehicle network system according to claim 1, wherein each of the electronic control units is configured to adjust the number of dynamic messages of the first priority and the number of dynamic messages of the second priority such that the total sum of the data lengths of the dynamic messages to be transmitted per unit of time to the communication bus does not exceed the allocation amount to the electronic control unit within the second bandwidth.

4. An electronic control unit that is configured to transmit and receive a static message and a dynamic message via a communication bus and that constitutes an in-vehicle network system including a plurality of the electronic control units, the electronic control unit comprising a processing circuit, wherein:
a total sum of data lengths of the static messages to be transmitted per unit of time to the communication bus is set not to exceed a first bandwidth within a bandwidth of the communication bus;
a bandwidth excluding the first bandwidth within the bandwidth of the communication bus is a second bandwidth; and
the processing circuit is configured to execute:
acquiring first request information that is information including the number of dynamic messages of a first priority and the number of dynamic messages of a second priority that is a lower priority than the first priority, among the dynamic messages to be transmitted from the processing circuit to the communication bus;
receiving second request information that is information to be transmitted from another electronic control unit that constitutes the in-vehicle network system, the information including the number of dynamic messages of the first priority and the number of dynamic messages of the second priority, among the dynamic messages to be transmitted from the other electronic control unit to the communication bus;
allocating, based on the first request information and the second request information, the second bandwidth to the electronic control units such that an allocation amount to an electronic control unit with a greater number of dynamic messages of the first priority is larger than an allocation amount to an electronic control unit with a smaller number of dynamic messages of the first priority, among the electronic control units that constitute the in-vehicle network system;
transmitting, to the other electronic control unit, bandwidth information that is information regarding an allocation amount to the other electronic control unit within the second bandwidth; and
adjusting the number of dynamic messages to be transmitted per unit of time to the communication bus such that a total sum of data lengths of the dynamic messages to be transmitted per unit of time to the communication bus does not exceed an allocation amount to the processing circuit within the second bandwidth.

5. An electronic control unit that is configured to transmit and receive a static message and a dynamic message via a communication bus and that constitutes an in-vehicle network system including a plurality of the electronic control units, the electronic control unit comprising a processing circuit, wherein:
a total sum of data lengths of the static messages to be transmitted per unit of time to the communication bus is set not to exceed a first bandwidth within a bandwidth of the communication bus;
a bandwidth excluding the first bandwidth within the bandwidth of the communication bus is a second bandwidth; and
the processing circuit is configured to execute:
transmitting, to another electronic control unit that constitutes the in-vehicle network system, request information that is information including the number of dynamic messages of a first priority and the number of dynamic messages of a second priority that is a lower priority than the first priority, among the dynamic messages to be transmitted from the processing circuit to the communication bus;
receiving bandwidth information that is information regarding an allocation amount to the processing circuit within the second bandwidth, the information being transmitted from the other electronic control unit; and
adjusting the number of dynamic messages to be transmitted per unit of time to the communication bus such that a total sum of data lengths of the dynamic messages to be transmitted per unit of time to the communication bus does not exceed the allocation amount to the processing circuit within the second bandwidth.
